(19) United States
(12) Patent Application Publication
(10) Pub. No.: US 2007/0156817 A1
(43) Pub. Date: Jul. 5, 2007

(54) Method for immediate delivery of email to telecommunication terminals

(75) Inventors: Klaus Daffner, Langen (DE); Hendrik Darpel, Koeln (DE); Jens Hake, Burkhardtsdorf (DE)

Correspondence Address: NORRIS, MCLAUGHLIN & MARCUS, 875 THIRD AVE, 18TH FLOOR, NEW YORK, NY, 10022, US

(73) Assignee: T-MOBILE DEUTSCHLAND GmbH, Bonn (DE)

(21) Appl. No.: 10/550,914

(22) PCT Filed: Apr. 1, 2004
(86) PCT No.: PCT/DE04/00702

§ 371 Date: Jan. 29, 2007

(30) Foreign Application Priority Data
Apr. 1, 2003 (DE) 103 14 915.5

(51) Int. Cl. G06F 15/16

(52) U.S. Cl. 709/206

(57) ABSTRACT

The invention relates to a method for immediately transmitting electronic messages to the telecommunication device of a receiver, preferably mobile, consisting in transmitting the electronic message from an emitter to a receiver by means of an electronic message server. According to said invention, the electronic messages are transmitted to the mobile telecommunication device of the receiver by means of a MMS or WAP system.

The invention relates to a method for immediate delivery (push delivery) of e-mails to telecommunication terminals via at least one telecommunication network. The telecommunication terminals can be both mobile and landline telecommunication terminals.

E-mails are typically retrieved using the pull-principle, i.e., an e-mail server must be polled periodically (manually or automatically) to find out if new e-mail messages have arrived. This represents a needless expense for a person polling the server, if no new messages have arrived, while e-mails are delivered only with a delay depending on the polling period.

New data services include so-called push-services. Unlike the pull-principle typically used in the Internet, these services transmit information to the corresponding terminals without polling. One example for the push technology in mobile terminals is the widespread SMS (Short Message Service). Lesser-known are MMS (Multimedia Messaging System) and push services via the Wireless Application Protocol (WAP), which can be used, for example, for system monitoring.

Systems which directly deliver e-mails to mobile clients are currently offered by a few manufacturers based on proprietary protocols. However, these systems require a special IT infrastructure at the subscriber and special mobile radio terminals. One example of such system is the communication terminal referred to as “Blackberry” from the company RIM (Research In Motion).

It is an object of the invention to provide a method and a device for the immediate delivery of e-mail, which does not require an additional IT infrastructure at the subscriber. The system should be compatible with conventional landline and wireless terminals, PDAs or Smartphones, and be based on open standards.

The object is solved according to the invention by the features of the independent claims.

Advantageously embodiments and modifications of the invention are recited in the dependent claims.

According to the disclosed method, incoming e-mails are directly delivered to the telecommunication terminal of the subscriber via conventional MMS or WAP push service, which already exist in mobile telecommunication networks.

According to a preferred embodiment of the invention, a special push server is provided in addition to the e-mail server of the e-mail provider. To be able to use the push mail service, the subscriber must establish forwarding at the e-mail server, so that incoming e-mails can be forwarded to a specially established “push e-mail” address (e.g., 491711234567@pushmail.t-mobile.de) of the push mail server. The push mail server automatically sends the e-mails to the e-mail client on the terminal for processing.

A subscriber account in the form of a database must be established on the push mail server for each subscriber. A component of this subscriber account is at least the telephone number of the intended terminal (or several terminals) of the subscriber, to which the push e-mails should be delivered, as well as the original e-mail address of the subscriber.

In a simplified embodiment of the invention, the database can be eliminated. By using a special configuration of the “push mail address (e.g., 491711234567@pushmail.t-mobile.de), the push mail server can readily determine the telephone number of the recipient from the “push mail” address.

The push mail server is connected to the MMS or WAP push system of the employed landline or mobile telecommunication network, preferably via a so-called Large Account, i.e., a MMS or WAP push access for transmitting large data volumes.

The push mail server must also encapsulate the e-mail in a suitable content type, so that the e-mail can be transmitted via the MMS or WAP push format. Advantageously, the content type “message/rfc822” which is already specified in the Internet standards can be used. The messages are then essentially divided into a body and a header. The body of a message contains the actual information to be sent. The content can be any combination of ASCII symbols, without regard for syntax rules. The header includes, among others, information about the recipient(s), the sender, priority, transmission time, encoding type, etc. The respective information is stored in header fields.

According to an advantageous embodiment of the invention, the push mail server can also include a billing mechanism, which can be used to produce toll tickets for the billing system of telecommunication network operators or other service providers.

According to another embodiment of the invention, the function of the push mail server is integrated directly in the existing e-mail server. In this case, the subscriber account can either be entirely omitted our at least simplified, because storing the original e-mail address is no longer necessary. Also no longer necessary is a special “push e-mail” address, i.e., explicitly forwarding of incoming e-mails to a special “push e-mail” address can be eliminated, if the functionality of the push mail server is integrated in the employed e-mail server.

The push e-mail client employed in the terminal can be a conventional WAP client or MMS client which is enhanced so as to detect encapsulated e-mails. When message content encapsulated with the aforementioned special content type, for example “message/rfc822”, is detected, the e-mail contained therein is extracted and transmitted to the e-mail client of the terminal.

The existing e-mail server must generally support automatic forwarding of the received e-mails, so that the e-mails can be forwarded to the push mail server. The application of forwarding rules prevents forwarding of unwanted e-mails, i.e., this subscriber can set rules which e-mails are to be treated as push e-mails and which e-mails are to be processed in a conventional manner.

If the function of the push mail server is integrated in the e-mail server, a suitable function for filtering the e-mails, which are to be transmitted to the mobile client, can be provided.

An exemplary embodiment of the method of the invention will now be described with reference to the drawing.

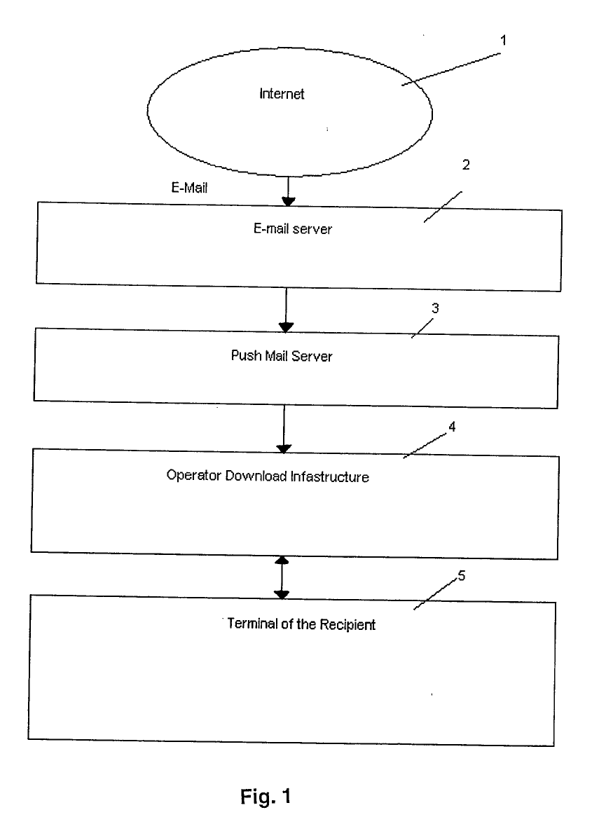

FIG. 1 shows a possible exemplary process flow in a mobile communication system.

An e-mail originating from the sender is transmitted via the Internet 1 to an e-mail server 2 of the recipient.

The e-mail is forwarded from the e-mail server 2 to an e-mail address established for the recipient on a push mail server 3. The recipient can define rules at the e-mail server 2, based on which the e-mails are forwarded to his/her e-mail address on the push mail server 3. The rules set criteria, for example message size, number of messages, sender, etc., based on which the e-mail is forwarded to the push mail server 3.

The forwarding rules are taken into account when the e-mail is forwarded to the push mail server 3.

The push mail server 3 determines from a database containing subscriber data the telephone number of the recipient, which is typically the telephone number of a mobile communication device. The telephone number of the recipient can also be determined from the address of the recipient in the forwarded e-mail instead of a database. The e-mail is encapsulated in a message with a suitable content type, e.g., encapsulation with content type “message/rfc822”.

The encapsulated e-mail is forwarded to the download infrastructure 4 of the communication network operator. The download infrastructure may include the following network components: MMSC (Multimedia Messaging Service Center), WAP Gateway, Push Proxy, and SMSC (Short Message Service Center), depending if the e-mail is transmitted via a MMS or a WAP push service.

The encapsulated e-mail is delivered to the terminal 5 of the recipient as MMS or WAP push download in a conventional manner.

The encapsulated message is received in the terminal 5. The WAP or MMS client at the terminal must detect the corresponding content type, e.g., “message/rfc822”, and unpack the message content of the corresponding content type and transmit the same to the corresponding locally installed e-mail client. The e-mail client signals to the recipient the presence of a new message.

### REFERENCE SYMBOLS IN THE DRAWING

1 Internet
2 E-mail Server
Subscriber defines the rules based on which the e-mails are forwarded to his/her e-mail address on a push mail server (message size, number of messages, sender, . . . )
3 Push Mail Server
determine telephone number of the recipient from a database containing customer data (or from the recipient's address of the forwarded e-mail)
encapsulate e-mail in a message with the suitable content type (e.g., encapsulation with content type “message/rfc822”)
4 Operator Download Infrastructure
MMSC+WAP GW+Push Proxy+SMSC
5 Terminal of the Recipient
receive encapsulated message
WAP or MMS client must detect the corresponding content type (e.g., “message/rfc822”)
unpack message content of the corresponding content type and transmit the same to the corresponding locally installed e-mail client
e-mail client signals to the recipient the presence of a new message.

1. A method for immediate delivery of an e-mail to a telecommunication device of a recipient via at least one telecommunication network, wherein the e-mail is transmitted from a sender via an e-mail server to the recipient, comprising the steps of
delivering the e-mail to a telecommunication terminal of the recipient via conventional MMS or WAP push systems, in that the e-mails are forwarded from the e-mail server to a specially configured push mail server based on the e-mail address of the recipient, from where they are delivered to the telecommunication terminal based on a telephone number, which is included in the e-mail or determined from a database, via conventional MMS or WAP push systems.

2. The method according to claim 1, wherein a subscriber account is established for each subscriber on the push mail server, the subscriber account including at least the telephone number of at least one telecommunication terminal and the original e-mail address of the recipient.

3. The method according to claim 1, wherein forwarding of the e-mail from the e-mail server to the push mail server is controlled by a device and by applying forwarding rules.

4. The method according to claim 1, wherein the push mail server determines the telephone number of the telecommunication terminal of the recipient from the employed push mail address.

5. The method according to claim 1, wherein the push mail server is connected to the MMS or WAP push systems of the employed telecommunication network.

6. The method according to claim 1, wherein the function of the push mail server is integrated directly in the existing e-mail server.

7. The method according to claim 1, wherein the push mail server encapsulates the e-mail in a suitable content type, so that the e-mail can be transmitted via MMS or WAP push format.

8. The method according to claim 1, wherein a “message/rfc822” is employed as a content type.

9. The method according to claim 1, wherein the push mail server includes a billing mechanism, which is used to produce toll tickets for the billing system of telecommunication network operators or other service providers.

10. The method according to one of the preceding claims, wherein a conventional WAP client or MMS client, which detects and processes encapsulated e-mails, is installed in the telecommunication terminal.

11. The method according to claim 1, wherein, if message units encapsulated with the special content type are detected, the e-mail contained therein is extracted and transmitted to the e-mail client of the telecommunication terminal.

12. A device for immediate delivery of e-mails to a telecommunication device of a recipient via at least one telecommunication network, with an e-mail server for transmitting the e-mails from a sender to the recipient, comprising
a telecommunication network including MMS or WAP push systems, and
a push server connected with the e-mail server for immediate delivery of the e-mails received by the e-mail server to the communication terminal of the recipient.

13. The device according to claim 12, wherein the telecommunication terminal is a mobile telecommunication terminal.

14. The device according to claim 12, wherein the telecommunication terminal is a landline telecommunication terminal.
